(19) United States
(12) Patent Application Publication
(10) Pub. No.: US 2022/0010103 A1
(43) Pub. Date: Jan. 13, 2022

(54) RUBBER COMPOSITION FOR CONVEYOR BELT AND CONVEYOR BELT

(71) Applicant: THE YOKOHAMA RUBBER CO., LTD., MINATO-KU, TOKYO (JP)

(72) Inventor: Saori YAGIHASHI, HIRATSUKA CITY, KANAGAWA (JP)

(21) Appl. No.: 17/295,276

(22) PCT Filed: Aug. 30, 2019
(86) PCT No.: PCT/JP2019/034110

§ 371 Date: May 19, 2021

(30) Foreign Application Priority Data
Nov. 28, 2018 (JP) 2018-222291

(51) Int. Cl. C08L 9/00; B65G 15/32; C08K 3/22; C08L 23/16

(52) U.S. Cl. CPC C08L 9/00; B65G 15/32; C08K 2003/2282; C08L 23/16; C08K 3/2279

(57) ABSTRACT

The present invention is to provide a rubber composition that can be a conveyor belt having excellent heat resistance and wear resistance, and a conveyor belt. An embodiment of the present invention is a rubber composition for a conveyor belt containing: per 100 parts by mass of a rubber component containing at least an ethylene-1-butene copolymer, from 1 to 10 parts by mass of antimony trioxide, and from 10 to 50 parts by mass of a compound represented by Formula (1). In Formula (1), R represents an aliphatic hydrocarbon group that may contain an unsaturated bond.

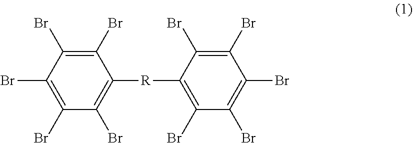

### TECHNICAL FIELD

The present invention relates to a rubber composition for a conveyor belt and a conveyor belt.

### BACKGROUND ART

In the related art, a belt conveyor has been used to continuously transport a conveyed object such as raw materials in, for example, iron mills or chemical plants. In general, a belt conveyor is a device to transport a conveyed object by moving or rotating a belt (conveyor belt) by driving gear such as rollers.

In the iron mill or plant described above, for example, a conveyor belt is required to have flame retardancy and heat resistance because frictional heat may be generated in a belt conveyor or a transported object may be at a high temperature.

Furthermore, a conveyor belt is required to have wear resistance to enable continuous conveyance.

Regarding a rubber composition used for formation of a cover rubber layer in such a conveyor belt, for example, Patent Document 1 describes, to provide, for example, a rubber composition that can allow a conveyor belt to exhibit excellent characteristics including flame retardancy, wear resistance, and heat resistance,

a rubber composition for cover rubber being used to form a cover rubber layer of a conveyor belt,

the rubber composition containing: a rubber and a bromine-based flame retardant,

the bromine-based flame retardant being contained in a manner that a mass of bromine is from 10 parts by mass to 35 parts by mass per 100 parts by mass of the rubber, and

a main component of the rubber being an ethylene-propylene rubber (EPR).

### CITATION LIST

### Patent Literature

Patent Document 1: JP 2018-024530 A

### SUMMARY OF INVENTION

### Technical Problem

In such circumstances, when the inventors of the present invention prepared a rubber composition containing an ethylene-propylene rubber using Patent Document 1 as a reference and evaluated this, it was found that, although such a rubber composition can maintain flame retardancy, heat resistance or wear resistance may not necessarily satisfy the level that has been required recently.

An object of the present invention is to provide a rubber composition that can form a conveyor belt having excellent heat resistance and wear resistance.

Another object of the present invention is to provide a conveyor belt having excellent heat resistance and wear resistance.

### Solution to Problem

As a result of diligent research to solve the problems described above, the present inventors found that a desired effect can be achieved by allowing predetermined amounts of antimony trioxide and a compound represented by a specific structural formula to be contained in a rubber component containing at least an ethylene-1-butene copolymer, and thus completed the present invention.

Embodiments of the present invention are based on the findings described above, and specifically, solve the problems described above by the following configurations.

[1] A rubber composition for a conveyor belt containing:

per 100 parts by mass of a rubber component containing at least an ethylene-1-butene copolymer,

from 1 to 10 parts by mass of antimony trioxide, and

from 10 to 50 parts by mass of a compound represented by Formula (1) below.

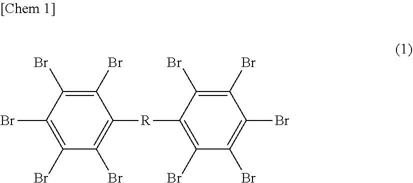

In Formula (1), R represents an aliphatic hydrocarbon group that may contain an unsaturated bond.

[2] The rubber composition for a conveyor belt described in [1], where a total content of the antimony trioxide and the compound represented by Formula (1) above is from 5 to 20 mass % relative to a total amount of the rubber composition for a conveyor belt.

[3] The rubber composition for a conveyor belt described in [1] or [2], where a content of the compound represented by Formula (1) is from 1 to 10 times a content of the antimony trioxide.

[4] The rubber composition for a conveyor belt described in any one of [1] to [3], where the rubber component further contains an ethylene-propylene copolymer 1 having a weight average molecular weight of greater than 100000.

[5] The rubber composition for a conveyor belt described in [4], where a mass ratio of the ethylene-propylene copolymer 1 to the ethylene-1-butene copolymer (ethylene-propylene copolymer 1/ethylene-1-butene copolymer) is from 5/95 to 95/5.

[6] The rubber composition for a conveyor belt described in [4] or [5], where a mass ratio of the ethylene-propylene copolymer 1 to the ethylene-1-butene copolymer (ethylene-propylene copolymer 1/ethylene-1-butene copolymer) is from 20/80 to 75/25.

[7] The rubber composition for a conveyor belt described in any one of [1] to [6], further containing a softener. [8] The rubber composition for a conveyor belt described in [7], where the softener contains at least an ethylene-propylene copolymer 2 having a weight average molecular weight of 100000 or less.

[9] The rubber composition for a conveyor belt described in [7] or [8], where a mass ratio of the softener to the compound represented by Formula (1) above (softener/compound represented by Formula (1)) is from 0.3 to 2.0.

[10] The rubber composition for a conveyor belt described in any one of [7] to [9], where a mass ratio of the softener to the compound represented by Formula (1) (softener/compound represented by Formula (1)) is from 0.67 to 0.80.

[11] The rubber composition for a conveyor belt described in any one of [7] to [10], where a content of the softener is from 5 to 30 parts by mass per 100 parts by mass of the rubber component.

[12] A conveyor belt produced by using the rubber composition for a conveyor belt described in any one of [1] to [11].

[13] The conveyor belt described in [12], including a cover rubber formed by using the rubber composition for a conveyor belt.

### Advantageous Effects of Invention

According to the rubber composition for a conveyor belt of an embodiment of the present invention, a conveyor belt having excellent heat resistance and wear resistance can be provided.

The conveyor belt according to an embodiment of the present invention has excellent heat resistance and wear resistance.

### BRIEF DESCRIPTION OF DRAWINGS

FIG. 1 is a cross-sectional view illustrating a conveyor belt of an embodiment of the present invention.

FIG. 2 is a cross-sectional view illustrating a conveyor belt of another embodiment of the present invention.

### DESCRIPTION OF EMBODIMENTS

Embodiments of the present invention will be described in detail below.

Note that, in the present specification, (meth)acrylate means acrylate or methacrylate.

Additionally, in the present specification, the value range indicated by using “from . . . to . . . ” means the range including the former value as a lower limit value and the later value as an upper limit value.

In the present specification, unless otherwise indicated, a substance corresponding to each component can be used alone or in combination of two or more types thereof. In a case where a component includes two or more types of substances, the component content means the total amount including the two or more types of substances.

In the present specification, the production method of each component is not particularly limited unless otherwise noted. Examples of the method include a known method.

In the present specification, the cases where at least one of heat resistance and wear resistance is superior may be referred to as “exhibiting superior effect of the present invention”.

### Rubber Composition for Conveyor Belt

The rubber composition for a conveyor belt according to an embodiment of the present invention (composition according to an embodiment of the present invention) is

a rubber composition for a conveyor belt containing:

per 100 parts by mass of a rubber component containing at least an ethylene-1-butene copolymer,

from 1 to 10 parts by mass of antimony trioxide, and

from 10 to 50 parts by mass of a compound represented by Formula (1) below.

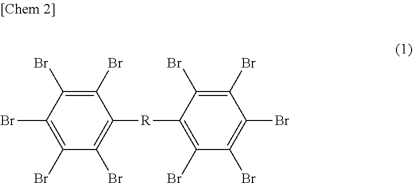

In Formula (1), R represents an aliphatic hydrocarbon group that may contain an unsaturated bond.

Note that the compound represented by Formula (1) above may be referred to as a particular compound.

The composition according to an embodiment of the present invention is thought to achieve desired effects as a result of having such a configuration. Although the reason is not clear, by allowing predetermined amounts of antimony trioxide that can function as a flame retardant auxiliary and the particular compound that can function as a flame retardant to be contained in the rubber component containing at least an ethylene-1-butene copolymer, it is presumed that heat resistance and wear resistance can be provided in a well-balanced manner to a high level.

Furthermore, because the composition according to an embodiment of the present invention contains antimony trioxide that can function as a flame retardant auxiliary and the particular compound that can function as a flame retardant as described above, according to the composition according to an embodiment of the present invention, a conveyor belt having excellent flame retardancy can be produced.

Each of the components included in the composition according to an embodiment of the present invention will be described in detail below.

### Rubber Component

The rubber component contained in the composition according to an embodiment of the present invention at least contains an ethylene-1-butene copolymer.

The composition according to an embodiment of the present invention contains the ethylene-1-butene copolymer and thus exhibits excellent heat resistance and wear resistance.

Ethylene-1-butene Copolymer

The ethylene-1-butene copolymer (EBM) which is at least contained in the rubber component is not particularly limited as long as the ethylene-1-butene copolymer is a copolymer of ethylene and 1-butene. Examples thereof include known ones.

An example of a preferable aspect is one in which the ethylene-1-butene copolymer is a copolymer formed from repeating units formed only from ethylene and 1-butene.

From the perspective of exhibiting superior effect of the present invention (especially, heat resistance), the Mooney viscosity of the ethylene-1-butene copolymer at 125° C. is preferably 20 or greater, more preferably 30 or greater, and even more preferably 40 or greater. Note that the upper limit value of the Mooney viscosity is not particularly limited but is preferably 70 or less, and more preferably 55 or less.

The Mooney viscosity at 125° C. is a viscosity (ML1+4, 125° C.) measured in accordance with JIS K6300-1:2013, using an L-shaped rotor under the conditions of a preheating time of 1 minute, a rotor rotation time of 4 minutes, and a test temperature of 125° C. (the same applies hereinafter).

The ethylene content of the ethylene-1-butene copolymer is not particularly limited but is preferably from 60 to 90 mass %, and more preferably from 65 to 85 mass %, relative to the amount of the ethylene-1-butene copolymer.

Note that, in an embodiment of the present invention, the ethylene content of the ethylene-1-butene copolymer can be calculated based on ASTM D 3900.

### Other Rubber Components

The rubber component may further contain another rubber component other than the ethylene-1-butene copolymer (other rubber component).

### Ethylene-propylene Copolymer 1

The other rubber component described above is preferably an ethylene-propylene copolymer 1 having a weight average molecular weight of greater than 100000 from the perspective of exhibiting superior effect of the present invention.

The ethylene-propylene copolymer 1 is not particularly limited as long as the ethylene-propylene copolymer 1 is a copolymer of ethylene and propylene and having a weight average molecular weight of greater than 100000. Examples thereof include known ones.

An example of a preferable aspect is one in which at least a part or all of repeating units by propylene constituting the ethylene-propylene copolymer 1 is —[CH(—CH₃)—CH₂]—. In this case, the ethylene-propylene copolymer 1 can have a branch by the —CH₃ moiety.

An example of a preferable aspect is one in which the ethylene-propylene copolymer 1 is a copolymer formed from repeating units formed only from ethylene and propylene.

From the perspective of exhibiting superior effect of the present invention, the weight average molecular weight of the ethylene-propylene copolymer 1 is preferably from 200000 to 500000, and more preferably from 250000 to 400000.

In an embodiment of the present invention, the weight average molecular weight of the ethylene-propylene copolymer 1 is a value obtained by gel permeation chromatography (GPC) measurement calibrated with polystyrene standards under the following conditions. The same applies to the weight average molecular weight of the ethylene-propylene copolymer 2 described below.
Solvent: Tetrahydrofuran
Detector: RI detector

The ethylene content of the ethylene-propylene copolymer 1 is preferably from 40 to 60 mass %, more preferably 40 mass % or greater and less than 60 mass %, and even more preferably from 45 to 55 mass %, from the perspective of exhibiting superior effect of the present invention (especially, heat resistance).

Note that, in an embodiment of the present invention, the ethylene content of the ethylene-propylene copolymer 1 can be calculated based on ASTM D 3900.

Other Rubber Component/ethylene-1-butene Copolymer

The mass ratio of the other rubber component to the ethylene-1-butene copolymer (other rubber component/ethylene-1-butene copolymer) is preferably from 95/5 to 0/100 from the perspective of exhibiting superior effect of the present invention (especially, heat resistance).

The case where all of the rubber component is the ethylene-1-butene copolymer (the above mass ratio is 0/100) is preferred because strength at break (TB) initially and after aging of the obtained vulcanized rubber is high.

Ethylene-propylene Copolymer 1/ethylene-1-butene Copolymer

In a case where the other rubber component described above is the ethylene-propylene copolymer 1, the mass ratio of the ethylene-propylene copolymer 1 to the ethylene-1-butene copolymer (ethylene-propylene copolymer 1/ethylene-1-butene copolymer) is preferably from 5/95 to 95/5, more preferably from 20/80 to 75/25, even more preferably from 50/50 to 70/30, and particularly preferably from 55/45 to 60/40, from the perspective of exhibiting superior effect of the present invention (especially, heat resistance), exhibiting excellent tensile properties (especially, elongation at break (EB) initially and after aging), exhibiting an appropriate range of strength at break after aging, and exhibiting a hardness (e.g. initial hardness, hardness after aging) that is not excessively high.

As the conveyor belt material, the hardness (e.g., initial hardness) of the rubber (conveyor belt) obtained from the rubber composition is preferably not excessively high because the conveyor belt easily follows deformation on a conveyor line and the conveyor belt can be stably operated.

### Antimony Trioxide

The antimony trioxide (Sb₂O₃) contained in the composition according to an embodiment of the present invention is not particularly limited.

In an embodiment of the present invention, the antimony trioxide can function as a flame retardant auxiliary for the particular compound described below.

### Content of Antimony Trioxide

In an embodiment of the present invention, the content of the antimony trioxide is from 1 to 10 parts by mass per 100 parts by mass of the rubber component.

By setting the content of the antimony trioxide to be in the range described above, the composition according to an embodiment of the present invention has excellent flame retardancy, heat resistance, and wear resistance.

The content of the antimony trioxide is preferably from 2.0 to 9.0 parts by mass, more preferably from 3.0 to 7.0 parts by mass, and even more preferably from 5.0 to 7.0 parts by mass, per 100 parts by mass of the rubber component from the perspective of exhibiting superior effect of the present invention and excellent flame retardancy.

### Compound Represented by Formula (1) (Particular Compound)

The particular compound contained in the composition according to an embodiment of the present invention is a compound represented by Formula (1) below.

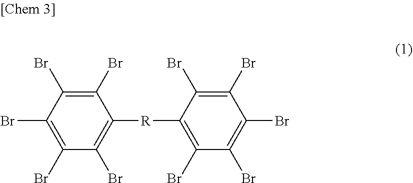

In Formula (1), R represents an aliphatic hydrocarbon group that may contain an unsaturated bond.

In an embodiment of the present invention, the particular compound can function as a flame retardant.

The aliphatic hydrocarbon group may be linear, branched, cyclic or any combination thereof. An example of a preferable aspect is a straight-chain.

The number of carbons of the aliphatic hydrocarbon group is not particularly limited. For example, the number of carbons may be from 1 to 10. The number of carbons is preferably from 2 to 8.

The aliphatic hydrocarbon group may be saturated or unsaturated. Examples of the unsaturated bond include a vinyl group, a vinylene group, an ethynyl group, and an ethynylene group.

Examples of the hydrocarbon group include a methylene group, an ethylene group, a trimethylene group, a propylene group, a butylene group, a pentylene group, a hexylene group, a heptylene group, and an octylene group.

Examples of the particular compound include bis(pentabromophenyl) ethane.

From the perspective of excellent flame retardancy, the particular compound is preferably bis(pentabromophenyl) ethane.

### Content of Particular Compound

In an embodiment of the present invention, the content of the particular compound is from 10 to 50 parts by mass per 100 parts by mass of the rubber component.

By setting the content of the particular compound to be in the range described above, the composition according to an embodiment of the present invention has excellent flame retardancy, heat resistance, and wear resistance.

From the perspective of exhibiting superior effect of the present invention and excellent flame retardancy, the content of the particular compound is preferably from 15.0 to 40.0 parts by mass, and more preferably from 17.0 to 30.0 parts by mass, per 100 parts by mass of the rubber component.

### Total Content of Antimony Trioxide and Particular Compound

The total content of the antimony trioxide and the particular compound is preferably from 5 to 20 mass %, more preferably from 7.0 to 20.0 mass %, even more preferably from 9.0 to 15.0 mass %, and particularly preferably from 11.3 to 14.0 mass %, relative to the total amount of the composition according to an embodiment of the present invention from the perspective of exhibiting superior effect of the present invention and excellent flame retardancy.

### Mass Ratio of Particular Compound to Antimony Trioxide

From the perspective of exhibiting superior effect of the present invention and excellent flame retardancy, the content of the compound represented by Formula (1) (particular compound) is preferably from 1 to 10 times, more preferably from 2.5 to 8.0 times, and even more preferably from 3.0 to 5.0 times, the content of the antimony trioxide.

### Softener

The composition according to an embodiment of the present invention can further contain a softener.

In a case where the composition according to an embodiment of the present invention further contains a softener, superior effect of the present invention (especially, heat resistance) is achieved.

In an embodiment of the present invention, the softener means a compound having a function to reduce the hardness or viscosity of the rubber component and/or a function to enhances mixability of the rubber component.

The softener is not particularly limited as long as the softener can be used for rubbers in general. Examples thereof include an ethylene-propylene copolymer 2 having a weight average molecular weight of 100000 or less and paraffin oil.

Examples of the paraffin oil include those containing a straight-chain aliphatic hydrocarbon. Note that the paraffin oil does not contain an ethylene-propylene copolymer.

Among these, the softener preferably contains at least an ethylene-propylene copolymer 2 having a weight average molecular weight of 100000 or less from the perspective of exhibiting superior effect of the present invention and excellent flame retardancy.

The ethylene-propylene copolymer 2 is not particularly limited as long as the ethylene-propylene copolymer 2 is a copolymer of ethylene and propylene and having a weight average molecular weight of 100000 or less.

An example of a preferable aspect is one in which at least a part or all of repeating units by propylene constituting the ethylene-propylene copolymer 2 is —[CH(—CH₃)—CH₂]—. In this case, the ethylene-propylene copolymer 2 can have a branch by the —CH₃ moiety.

An example of a preferable aspect is one in which the ethylene-propylene copolymer 2 is a copolymer formed from repeating units formed only from ethylene and propylene.

From the perspective of exhibiting superior effect of the present invention, the weight average molecular weight of the ethylene-propylene copolymer 2 is preferably 50000 or less, more preferably from 5000 to 25000, and even more preferably from 5500 to 20000.

### Softener/Compound Represented by Formula (1)

The mass ratio of the softener to the compound represented by Formula (1) above (softener/compound represented by Formula (1)) is preferably from 0.3 to 2.0, and more preferably from 0.67 to 0.80, from the perspective of exhibiting superior effect of the present invention and excellent flame retardancy.

### Content of Softener

From the perspective of exhibiting superior effect of the present invention and excellent flame retardancy, the content of the softener is preferably from 5 to 30 parts by mass, and more preferably from 10.0 to 20.0 parts by mass, per 100 parts by mass of the rubber component.

### Crosslinking Agent

The composition according to an embodiment of the present invention may further contain a crosslinking agent. Examples of the crosslinking agent include organic peroxide and metal carboxylate.

The organic peroxide is not particularly limited and a known organic peroxide can be used. Specific examples thereof include dicumyl peroxide, di-t-butyl peroxide, 1,3-bis(t-butylperoxyisopropyl)benzene, n-butyl 4,4′-di(t-butylperoxy)valerate, and 2,5-dimethyl-2,5-bis(t-butylperoxy)hexane.

As the organic peroxide, a commercially available product can be used. Specific examples thereof include 1,3-bis(t-butylperoxyisopropyl)benzene (trade name “Perkadox 14-40,” available from Kayaku Akzo Corporation).

Examples of the metal carboxylate include magnesium salts such as magnesium (meth)acrylate.

As the metal carboxylate, a commercially available product can be used, and specific examples thereof include magnesium methacrylate (trade name: HiCross GT″ (available from Seiko Chemical Co., Ltd.)).

The content of the crosslinking agent is not particularly limited. For example, the content can be appropriately selected based on those in the related art.

### Optional Component

In addition to the components described above, the composition according to an embodiment of the present invention may further contain additives that are typically used, such as carbon black, flowers of zinc (zinc oxide), stearic acid, and anti-aging agents, in the range that does not impair the object of the present invention. The content of these additives may be appropriately selected in the range that does not impair the object of the present invention.

The production of the composition according to an embodiment of the present invention can be performed by known conditions and methods. The composition according to an embodiment of the present invention can be produced by mixing the components described above by using, for example, a Banbury mixer, kneader, or roll mill.

### Conveyor Belt

The conveyor belt according to an embodiment of the present invention will be described below.

The conveyor belt according to an embodiment of the present invention is a conveyor belt produced by using the composition according to an embodiment of the present invention. For example, the shape and production method thereof are identical to those of known conveyor belts.

The composition according to an embodiment of the present invention can be applied to any component of the conveyor belt according to an embodiment of the present invention without particular limitation. All or a part of the rubber constituting the conveyor belt according to an embodiment of the present invention is only required to be formed from the composition according to an embodiment of the present invention.

Since the composition according to an embodiment of the present invention has excellent heat resistance, wear resistance, and flame retardancy as described above, an example of a preferable aspect is one in which the conveyor belt according to an embodiment of the present invention has a cover rubber formed by using the composition according to an embodiment of the present invention.

Examples of the specific structure of the conveyor belt according to an embodiment of the present invention are described below. Note that the conveyor belt according to an embodiment of the present invention is not limited to the attached drawings.

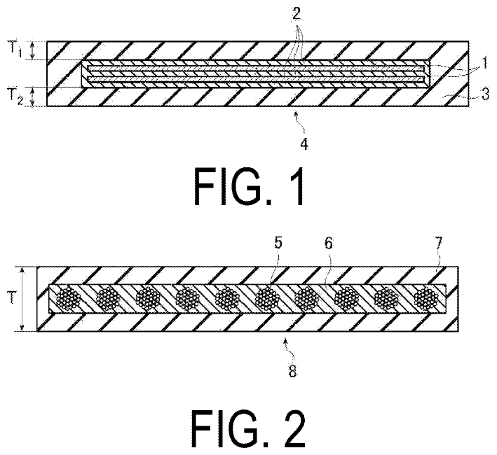

The first embodiment of the conveyor belt according to an embodiment of the present invention is described by using FIG. 1.

FIG. 1 is a cross-sectional view illustrating a conveyor belt of an embodiment of the present invention. As illustrated in FIG. 1, the conveyor belt of the first embodiment of the present invention is a conveyor belt 4 that is formed by covering a fabric layer 1 with a coating rubber (adhesive rubber) 2 to form a core material layer and covering the periphery of the core material layer with a cover rubber 3. The cover rubber 3 is preferably formed from the composition according to an embodiment of the present invention.

The conveyor belt 4 of FIG. 1 has a fabric layer 1 as the core material and, for example, the number of laminated sheets of the fabric layer 1, and thickness and belt width of the cover rubber 3 can be appropriately selected depending on the use.

Examples of the fabric layer include canvas formed from woven fabric of synthetic fibers such as nylon, vinylon, and polyester.

The thicknesses T₁ and T₂ of the cover rubber 3 can be set to from approximately 1.5 to 20 mm in typical cases.

Furthermore, as the coating rubber 2, coating rubbers that are used in known conveyor belts can be used. For example, a rubber composition containing natural rubber (NR), acrylonitrile-butadiene rubber (NBR), styrene-butadiene copolymer rubber (SBR), butadiene rubber (BR), ethylene-propylene rubber (EPT), or ethylene-propylene-diene rubber (EPDM) as a rubber component can be used.

Next, the conveyor belt of the second embodiment of the present invention is described using FIG. 2.

FIG. 2 is a cross-sectional view illustrating a conveyor belt of another embodiment of the present invention.

As illustrated in FIG. 2, the conveyor belt of the second embodiment of the present invention is a conveyor belt 8 that is formed by covering a steel cord 5 with a cushion rubber (adhesive rubber) 6 to form a core material layer and covering the periphery of the core material layer with a cover rubber 7. The cover rubber 7 is preferably formed from the composition according to an embodiment of the present invention.

For the conveyor belt 8, approximately from 50 to 230 steel cords 5 formed by intertwining a plurality of wire strands having a diameter from approximately 0.2 to 0.4 mm, the steel cord 5 having a diameter from approximately 2.0 to 9.5 mm, being arranged in parallel can be used as a core material. In general, the total thickness T of the conveyor belt 8 can be approximately from 10 to 50 mm.

Furthermore, for the cushion rubber 6, for example, adhesive rubbers that can be adhered to zinc-plated steel cords used in known steel conveyor belts can be used. Specifically, for example, a rubber composition containing natural rubber (NR), acrylonitrile-butadiene rubber (NBR), styrene-butadiene copolymer rubber (SBR), or butadiene rubber (BR), as a rubber component can be used.

For example, the conveyor belt according to an embodiment of the present invention can be easily produced, in accordance with an ordinary method, by interposing a fabric layer or steel cords that become core material(s) in between unvulcanized rubber sheets formed from the composition according to an embodiment of the present invention, and then vulcanizing by press-heating. Note that, for example, the vulcanization condition is typically at approximately 120 to 180° C. under approximately from 0.1 to 4.9 MPa for approximately 10 to 90 minutes.

Since the conveyor belt according to an embodiment of the present invention uses the composition according to an embodiment of the present invention described above, the conveyor belt has excellent heat resistance and wear resistance, and excellent flame retardancy.

### Example

An embodiment of the present invention will be described below in detail by way of examples. However, an embodiment of the present invention is not limited to such examples.

### Production of Composition

The components shown in Table 1 below were used in compositions (part by mass) shown in the same table and mixed by a Banbury mixer, and thus a composition was produced.

### Flame Retardancy

### Preparation of Sample for Flame Retardancy Evaluation

Using each of the compositions produced as described above, a sample (dimension of the sample was 200 mm long side and 25 mm short side) was prepared in accordance with 7.2.1 fabric layer conveyor rubber of JIS K 6324:2013 “Flame resistant conveyor belts-Classification and test method”, and the obtained sample was used as a sample for flame retardancy evaluation. In each of the samples for flame retardancy evaluation (flame retardant conveyor belt), the used composition described above formed the cover rubber, and the fabric layer formed the core material.

### Evaluation of Flame Retardancy (Flame Extinguishing Time)

Evaluation Methods

The flame retardancy was evaluated based on flame retardancy evaluation (fire extinguishing time, unit: second) of JIS K 6324:2013 “Flame resistant conveyor belts-Classification and test method” by using the sample for flame retardancy evaluation obtained as described above. The results are shown in Table 1.

Evaluation Criteria

In an embodiment of the present invention, a case where the flame extinguishing time was less than 60 seconds was evaluated as exhibiting excellent flame retardancy and shown as “Good”.

A case where the flame extinguishing time was 60 seconds or longer was evaluated as exhibiting poor flame retardancy.

### Tensile Property, Hardness

### Preparation for Sample for Evaluating Tensile Properties

Sample for Evaluating Initial Tensile Properties

Using a 160° C. press molding machine, each of the compositions obtained as described above was vulcanized for 45 minutes under a surface pressure of 3.0 MPa to produce a vulcanized sheet having a thickness of 2 mm.

A dumbbell-shaped JIS No. 3 test piece was punched from this sheet, and thus a sample for evaluating initial tensile properties was obtained.

Sample for Evaluating Tensile Properties after Aging (180° C.×168 Hours)

The sample for evaluating initial tensile properties obtained as described above was subjected to an aging test by which the sample was placed under a condition at 180° C. for 168 hours. The sample obtained after the aging test is referred to as “sample for evaluating tensile properties after aging”.

### Tensile Test

Initial Tensile Properties

For each of the samples for evaluating initial tensile properties obtained as described above, strength at break (TB, unit: MPa) and elongation at break (EB, unit: %) were measured by performing a tensile test at a tensile speed of 500 mm/min at room temperature condition in accordance with JIS K6251:2017.

The results are shown in “initial TB” and “initial EB” sections of Table 1.

The initial TB is preferably 8.0 MPa or greater, and more preferably 11.5 MPa or greater.

The initial EB is preferably 450% or greater, and more preferably 500% or greater.

Tensile Properties after Aging (180° C.×168 Hours)

For each of the samples for evaluating tensile properties after aging obtained as described above, the tensile test was performed in the manner identical to that described above.

The results are shown in “TB after 180° C.×168 hours” and “EB after 180° C.×168 hours” sections of Table 1.

The TB after 180° C.×168 hours is preferably 6.0 MPa or greater, and more preferably 8.0 MPa or greater.

The EB after 180° C.×168 hours is preferably 300% or greater, more preferably 400% or greater, and even more preferably 500% or greater.

### Hardness

Initial Hardness

For each of the samples for evaluating initial tensile properties obtained as described above, initial hardness (Hs) was measured at 23° C. condition by using a spring-type, type A hardness tester at room temperature condition in accordance with JIS K6253-3:2012. The results are shown in “initial Hs” section of Table 1.

The initial hardness is preferably from 60 to 75, more preferably from 63 to 72, even more preferably from 65 to 70, and particularly preferably from 68 to 70.

Hardness after Aging (180° C.×168 Hours)

For each of the samples for evaluating tensile properties after aging obtained as described above, the hardness (Hs) after aging (180° C.×168 hours) was measured in the manner identical to that described above.

The results are shown in “Hs after 180° C.×168 hours” section of Table 1.

The hardness after 180° C.×168 hours is preferably 80 or less, and more preferably 76 or less.

### Heat Resistance

Percentage of Change (%) of EB

The values of the initial EB and the EB after aging (180° C.×168 hours) measured as described above were applied to the following equation, and a percentage [%] of change of elongation after 180° C.×168 hours was determined. The results are shown in “heat resistance” section of Table 1.

Percentage of change of elongation 180° C.×168 hours (%)={((EB after 180° C.×168 hours)−(initial EB))/(initial EB)}×100

Evaluation Criteria

In an embodiment of the present invention, a case where the value of percentage of change of elongation at break was −35% or greater was evaluated as exhibiting excellent heat resistance.

A case where the percentage of change was −22% or greater was evaluated as exhibiting even better heat resistance. Note that, regardless of the value of the percentage of change being plus or minus, a value closer to 0% indicates more preferable heat resistance.

A case where the value of percentage of change of elongation at break was less than −35% was evaluated as exhibiting poor heat resistance.

### Wear Resistance

### Preparation of Sample for Wear Resistance Evaluation

(Initial) Vulcanization Test Sample

Using a 160° C. press molding machine, the composition obtained as described above was vulcanized for 45 minutes under a surface pressure of 3.0 MPa, and an (initial) vulcanized test sample having a diameter of 16 mm and a thickness of 6 mm was produced.

### Wear Test

Wear Test

Using each of the (initial) vulcanized test samples obtained as described above as a sample for wear resistance evaluation, the amount of wear [mm³] was measured by performing a wear test at room temperature using a DIN wear test machine, in accordance with JIS K 6264-2:2005. The results are shown in Table 1.

Evaluation Criteria

In an embodiment of the present invention, a case where the amount of wear was 160 mm³ or less was evaluated as exhibiting excellent wear resistance.

A smaller amount of wear indicates superior wear resistance. A case where the amount of wear was 150 mm³ or less exhibited superior wear resistance.

A case where the amount of wear was greater than 160 mm³ was evaluated as exhibiting poor wear resistance.

TABLE 1

| | Comparative | Comparative | Comparative | Comparative | Comparative | Example |
|---|---|---|---|---|---|---|
| Table 1 | Example 1 | Example 2 | Example 3 | Example 4 | Example 5 | 1 |
| Ethylene-propylene copolymer (KEP-110) | 100 | 100 | 100 | | 100 | |
| Ethylene-1-butene copolymer (ENGAGE 7487) | | | | 100 | | 100 |
| Softener 1 (Lucant HC-3000X) | 15 | 15 | 15 | 15 | | 15 |
| Softener 2 (paraffin oil) | | | | | 15 | |
| ISAF grade carbon black | 50 | 50 | 50 | 50 | 50 | 50 |
| Zinc oxide | 5 | 5 | 5 | 5 | 5 | 5 |
| Stearic acid | 1 | 1 | 1 | 1 | 1 | 1 |
| Anti-aging agent (NOCRAC MMB) | 9 | 9 | 9 | 9 | 9 | 9 |
| Crosslinking agent 1 (HiCross GT) | 3 | 3 | 3 | 3 | 3 | 3 |
| Crosslinking agent 2 (Perkadox 14/40) | 5.5 | 5.5 | 5.5 | 5.5 | 5.5 | 5.5 |
| Antimony trioxide | 6 | 6 | 3 | 6 | 6 | 6 |
| Compound 1 represented by Formula (1): | 20 | 30 | 20 | 55 | 20 | 20 |
| bis(pentabromophenyl) ethane (SAYTEX 8010) | | | | | | |
| Composition total amount | | | | | | 214.5 |
| Total content of antimony trioxide and compound | | | | | | 26 |
| represented by Formula (1) | | | | | | |
| Total content relative to total amount of composition | | | | | | 12.1 |
| (%) | | | | | | |
| Proportion of content of compound represented by | | | | | | 3.3 |
| Formula (1) relative to content of antimony trioxide (- | | | | | | |
| fold) | | | | | | |
| Softener/compound represented by Formula (1) (mass | | | | | | 0.75 |
| ratio) | | | | | | |
| Flame retardancy Flame extinguishing time Good: less | Good | Good | Good | Good | Good | Good |
| than 60 s Poor: 60 s or longer | | | | | | |
| Heat resistance (percentage of change of elongation | −25 | −21 | −24 | −22 | −36 | −7 |
| after aging at 180° C. × 168 hours) | | | | | | |
| Wear resistance (unit: mm³) | 164 | 180 | 165 | 182 | 185 | 142 |
| Initial Hs | 66 | 67 | 66 | 77 | 75 | 73 |
| Initial TB (MPa) | 11.3 | 10.6 | 11.4 | 12.6 | 12.9 | 14.0 |
| Initial EB (%) | 495 | 402 | 504 | 359 | 443 | 503 |
| Hs after 180° C. × 168 hours | 73 | 74 | 73 | 84 | 81 | 80 |
| TB after 180° C. × 168 hours (MPa) | 6.8 | 5.8 | 7.0 | 7.5 | 8.3 | 9.5 |
| EB after 180° C. × 168 hours (%) | 373 | 319 | 384 | 280 | 284 | 468 |

| | Example | Example | Example | Example | Example | Example |
|---|---|---|---|---|---|---|
| Table 1 | 2 | 3 | 4 | 5 | 6 | 7 |
| Ethylene-propylene copolymer (KEP-110) | | 40 | 40 | 60 | 60 | |
| Ethylene-1-butene copolymer (ENGAGE 7487) | 100 | 60 | 60 | 40 | 40 | 100 |
| Softener 1 (Lucant HC-3000X) | 15 | 15 | 15 | 15 | 15 | |
| Softener 2 (paraffin oil) | | | | | | 15 |
| ISAF grade carbon black | 50 | 50 | 50 | 50 | 50 | 50 |
| Zinc oxide | 5 | 5 | 5 | 5 | 5 | 5 |
| Stearic acid | 1 | 1 | 1 | 1 | 1 | 1 |
| Anti-aging agent (NOCRAC MMB) | 9 | 9 | 9 | 9 | 9 | 9 |
| Crosslinking agent 1 (HiCross GT) | 3 | 3 | 3 | 3 | 3 | 3 |
| Crosslinking agent 2 (Perkadox 14/40) | 5.5 | 5.5 | 5.5 | 5.5 | 5.5 | 5.5 |
| Antimony trioxide | 3 | 6 | 3 | 6 | 3 | 6 |
| Compound 1 represented by Formula (1): | 20 | 20 | 20 | 20 | 20 | 20 |
| bis(pentabromophenyl) ethane (SAYTEX 8010) | | | | | | |
| Composition total amount | 211.5 | 214.5 | 211.5 | 214.5 | 211.5 | 214.5 |
| Total content of antimony trioxide and compound | 23 | 26 | 23 | 26 | 23 | 26 |
| represented by Formula (1) | | | | | | |
| Total content relative to total amount of composition | 10.9 | 12.1 | 10.9 | 12.1 | 10.9 | 12.1 |
| (%) | | | | | | |
| Proportion of content of compound represented by | 6.7 | 3.3 | 6.7 | 3.3 | 6.7 | 3.3 |
| Formula (1) relative to content of antimony trioxide (- | | | | | | |
| fold) | | | | | | |
| Softener/compound represented by Formula (1) (mass | 0.75 | 0.75 | 0.75 | 0.75 | 0.75 | 0.75 |
| ratio) | | | | | | |
| Flame retardancy Flame extinguishing time Good: less | Good | Good | Good | Good | Good | Good |
| than 60 s Poor: 60 s or longer | | | | | | |
| Heat resistance (percentage of change of elongation | −6 | −20 | −19 | −22 | −21 | −12 |
| after aging at 180° C. × 168 hours) | | | | | | |
| Wear resistance (unit: mm³) | 143 | 141 | 142 | 148 | 149 | 140 |
| Initial Hs | 73 | 71 | 71 | 69 | 69 | 73 |
| Initial TB (MPa) | 14.1 | 12.4 | 12.5 | 11.5 | 11.6 | 14.5 |
| Initial EB (%) | 512 | 648 | 659 | 639 | 650 | 489 |
| Hs after 180° C. × 168 hours | 80 | 77 | 77 | 76 | 76 | 80 |
| TB after 180° C. × 168 hours (MPa) | 9.8 | 6.6 | 6.8 | 6.1 | 6.3 | 10.0 |
| EB after 180° C. × 168 hours (%) | 482 | 519 | 535 | 500 | 515 | 431 |

Details of each component indicated in Table 1 are as follows.
Ethylene-propylene copolymer (KEP-110): ethylene-propylene copolymer, trade name “KEP-110” (available from Kumho Polychem). The weight average molecular weight of the ethylene-propylene copolymer is 310000, and the ethylene content thereof is 52 mass %. Note that the ethylene-propylene copolymer (KEP-110) corresponds to the ethylene-propylene copolymer 1 because the weight average molecular weight is greater than 100000. In the ethylene-propylene copolymer, at least a part or all of repeating units by propylene is —CH(—CH₃)—CH₂—, and thus has a branch by the —CH₃ moiety.
Ethylene-1-butene copolymer (ENGAGE 7487): ethylene-1-butene copolymer, trade name “Engage 7487” (available from the Dow Chemical Company). The Mooney viscosity at 125° C. of the ethylene-1-butene copolymer is 47, and the ethylene content thereof is 74 mass %.
Softener 1 (Lucant HC-3000X): trade name “Lucant HC-3000X” (available from Mitsui Chemicals, Inc.) Ethylene-propylene copolymer having a weight average molecular weight of 14000. Since the softener 1 is an ethylene-propylene copolymer having a weight average molecular weight of 100000 or less, the softener 1 corresponds to the ethylene-propylene copolymer 2. In the softener 1, at least a part or all of repeating units by propylene is —CH(—CH₃)—CH₂—, and thus has a branch by the —CH₃ moiety.
Softener 2 (paraffin oil): petroleum-based straight-chain saturated hydrocarbon. Trade name: SUNPAR 2280, available from Japan Sun Oil Company, Ltd.
ISAF grade carbon black: trade name “Niteron #300” (available from Nippon Steel Carbon Co., Ltd.)
Zinc oxide: Flowers of zinc. Trade name “Zinc Oxide III” (available from Seido Chemical Industry Co., Ltd.)
Stearic acid: trade name “stearic acid 50S” (available from Chiba Fatty Acid Co., Ltd.)
Anti-aging agent (NOCRAC MMB): trade name “NOCRAC MMB” (available from Ouchi Shinko Chemical Industrial Co., Ltd.)
Crosslinking agent 1 (HiCross GT): trade name “HiCross GT” (available from Seiko Chemical Co., Ltd.)
Crosslinking agent 2 (Perkadox 14/40): trade name “Perkadox 14-40” (available from Kayaku Akzo Corporation)
Antimony trioxide: trade name “PATOX-M” (available from Nihon Seiko Co., Ltd.)
Compound 1 represented by Formula (1): bis(pentabromophenyl) ethane. Trade name “SAYTEX8010” (available from Albemarle Corporation)

As is clear from the results shown in Table 1, Comparative Examples 1 to 3 containing no ethylene-1-butene copolymer but, instead, containing an ethylene-propylene copolymer, which had a weight average molecular weight of greater than 100000, exhibited poor wear resistance.

Comparative Example 4 in which the content of the compound represented by Formula (1) was greater than the predetermined range exhibited poor wear resistance. Comparative Example 5 containing no ethylene-1-butene copolymer but, instead, containing an ethylene-propylene copolymer, which had a weight average molecular weight of greater than 100000, and containing a paraffin oil as a softener exhibited poor heat resistance and wear resistance.

On the other hand, the compositions according to an embodiment of the present invention exhibited excellent heat resistance and wear resistance.

Furthermore, the composition according to an embodiment of the present invention exhibited excellent flame retardancy.

When Comparative Example 1 containing an ethylene-propylene copolymer (ethylene-propylene rubber: EPR) having the weight average molecular weight of greater than 100000 and Example 1 are compared, Comparative Example 1 exhibited lower heat resistance and wear resistance than those of Example 1 although Comparative Example 1 had the content of the antimony trioxide of 1 to 10 parts by mass and the content of the compound represented by Formula (1) of 10 to 50 parts by mass.

The comparison between Comparative Example 3 and Example 2 exhibited a result similar to that of the comparison between Comparative Example 1 and Example 1.

As described above, by replacing an ethylene-propylene copolymer having a weight average molecular weight of greater than 100000 with the ethylene-1-butene copolymer, the composition according to an embodiment of the present invention exhibits excellent heat resistance in addition to wear resistance.

### REFERENCE SIGNS LIST

1 Fabric layer
2 Coating rubber
3,7 Cover rubber
4,8 Conveyor belt
5 Steel cord
6 Cushion rubber

1. A rubber composition for a conveyor belt comprising:
per 100 parts by mass of a rubber component containing at least an ethylene-1-butene copolymer,
from 1 to 10 parts by mass of antimony trioxide, and
from 10 to 50 parts by mass of a compound represented by Formula (1): 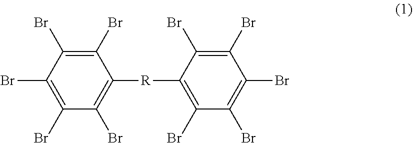
where R represents an aliphatic hydrocarbon group that may contain an unsaturated bond.

2. The rubber composition for a conveyor belt according to claim 1, wherein a total content of the antimony trioxide and the compound represented by Formula (1) is from 5 to 20 mass % relative to a total amount of the rubber composition for a conveyor belt.

3. The rubber composition for a conveyor belt according to claim 1, wherein a content of the compound represented by Formula (1) is from 1 to 10 times a content of the antimony trioxide.

4. The rubber composition for a conveyor belt according to claim 1, wherein the rubber component further contains an ethylene-propylene copolymer 1 having a weight average molecular weight of greater than 100000.

5. The rubber composition for a conveyor belt according to claim 4, wherein a mass ratio of the ethylene-propylene copolymer 1 to the ethylene-1-butene copolymer (ethylene-propylene copolymer 1/ethylene-1-butene copolymer) is from 5/95 to 95/5.

6. The rubber composition for a conveyor belt according to claim 4, wherein a mass ratio of the ethylene-propylene copolymer 1 to the ethylene-1-butene copolymer (ethylene-propylene copolymer 1/ethylene-1-butene copolymer) is from 20/80 to 75/25.

7. The rubber composition for a conveyor belt according to claim 1, further comprising a softener.

8. The rubber composition for a conveyor belt according to claim 7, wherein the softener contains at least an ethylene-propylene copolymer 2 having a weight average molecular weight of 100000 or less.

9. The rubber composition for a conveyor belt according to claim 7, wherein a mass ratio of the softener to the compound represented by Formula (1) (softener/compound represented by Formula (1)) is from 0.3 to 2.0.

10. The rubber composition for a conveyor belt according to claim 7, wherein a mass ratio of the softener to the compound represented by Formula (1) (softener/compound represented by Formula (1)) is from 0.67 to 0.80.

11. The rubber composition for a conveyor belt according to claim 7, wherein a content of the softener is from 5 to 30 parts by mass per 100 parts by mass of the rubber component.

12. A conveyor belt produced by using the rubber composition for a conveyor belt according to claim 1.

13. The conveyor belt according to claim 12, comprising a cover rubber formed by using the rubber composition for a conveyor belt.
